(19) United States
(12) Patent Application Publication
(10) Pub. No.: US 2009/0222855 A1
(43) Pub. Date: Sep. 3, 2009

(54) Method and apparatuses for hierarchical transmission/reception in digital broadcast

(76) Inventors: Jani Vare, Kaarina (FI); Harri Pekonen, Raisio (FI); Tommi Auranen, Turku (FI); Miska Hannuksela, Ruutana (FI); Pekka Talmola, Turku (FI); Jussi Vesma, Turku (FI)

Correspondence Address: HARRINGTON & SMITH, PC, 4 RESEARCH DRIVE, Suite 202, SHELTON, CT, 06484-6212, US

(21) Appl. No.: 11/920,372

(22) PCT Filed: May 24, 2005
(86) PCT No.: PCT/FI2005/000239

§ 371 Date: Dec. 8, 2008

(51) Int. Cl. H04N 5/445; H04N 5/40; H04N 5/44

(52) U.S. Cl. 725/39; 348/724; 348/725; 348/E05.094; 348/E05.096

(57) ABSTRACT

In accordance with various aspects of the invention, there is being provided a method and apparatus for transmitting, and a method and apparatus for receiving a digital broadcast signal including a hierarchical modulation having a high priority stream and a low priority stream. The content to be received or transmitted in encoded into two stream so that a first stream is configured to be transmitted or received with the high priority stream, and a second stream to be transmitted/received with the low priority stream is configured to contain additional information for increasing the bitrate of the first stream.

### TECHNICAL FIELD OF THE INVENTION

The invention concerns an apparatus for transmitting and/or receiving a digital broadcast signal using a hierarchical modulation. Furthermore the invention concerns use of such apparatuses.

### BACKGROUND ART

Nowadays the multimedia content broadcast, particularly TV content, to handheld battery operated devices (like a cellular mobile phone or a PDA) is being consider as a promising business opportunity.

Digital broadband wireless broadcast technologies like DVB-H (Digital Video Broadcasting—handheld), DVB-T (Digital Video Broadcasting—Terrestrial), DMB-T (Digital Multimedia Broadcast-Terrestrial), T-DMB (Terrestrial Digital Multimedia Broadcasting) and MediaFLO (Forward Link Only) as examples can be used for building such services. There are a number of international Forums and R&D projects devoted to standardise, assess and lobby the technology and the business opportunities that is raising: CBMS (Convergence of Broadcast and Mobile Services), MBMS (Multimedia Broadcast Multicast Service), OMA (Open Mobile Alliance), BMCO (Broadcast_Mobile_Convergence) forum, DigiTAG (Digital terrestrial television action group), IP Datacast Forum.

One of the most interesting characteristics of the DVB-T/H standard is the ability to build networks that are able to use hierarchical modulation. Generally, these systems share the same RF channel for two independent multiplexes.

In the hierarchical modulation, the possible digital states of the constellation (i.e. 64 states in case of 64-QAM, 16 states in case of 16-QAM) are interpreted differently than in the non-hierarchical case.

In particular, two separate data streams can be made available for transmission: a first stream (HP: high priority) is defined by the number of the quadrant in which the state is located (e.g. a special QPSK stream), a second stream (LP: Low Priority) is defined by the location of the state within its quadrant (e.g. a 16-QAM or a QPSK stream).

In such a known system there has been proposed to send the same video content with two different resolutions/detail levels with the hierarchical modulation for example for use in receivers such as IRDs (Integrated Receiver Decoder) having different capabilities and being in different receiving conditions. In FIG. 1 IRD A is used for describing service intended for a mobile receiver in outdoor receiving conditions, wherein IRD C is used for describing service intended for a portable receiver in outdoor receiving conditions according to ETSI TR 102 377. The lower resolution would use HP and the higher resolution would use LP. The same content is therefore disadvantageously sent twice as can be seen from the FIG. 1.

For example there are two content streams: low resolution 5 Mbit/s and high resolution 10 Mbits/s. In the hierarchical mode, we have to select QPSK for HP and 16QAM for LP to have enough capacity for the transmission. The problem with this selection is that for LP:16QAM performance is worse than non-hierarchical 64QAM. Therefore the mobile reception possibilities for the LP stream are very limited.

If, on the other hand, QPSK is selected for HP and for LP there is being selected QPSK, the mobile reception capability is adequate (equal to non-hierarchical 16QAM). However, using this solution we have to limit the number of services, because there is not enough capacity in LP for the higher resolution streams.

### SUMMARY OF THE INVENTION

It is therefore an object of the invention to adapt encoding of the hierarchical modulation to flexibly tie the capacity and performance requirements.

In accordance with various aspects of the invention, there is being provided a method and apparatus for transmitting, and a method and apparatus for receiving a digital broadcast signal comprising a hierarchical modulation having a high priority multimedia stream and a low priority multimedia stream. Each multimedia stream may contain one or more media streams of a particular coding type as well as associated signalling. At least one source of media content to be received or transmitted is encoded into two streams so that a first stream is configured to be transmitted or received with the high priority stream, and a second stream to be transmitted or received with the low priority stream is configured to contain additional information for increasing the bitrate of the first stream.

Yet further embodiments of the invention have been specified in the dependent claims and in the description of further embodiments.

### BRIEF DESCRIPTION OF THE DRAWINGS

The invention will now be described, by way of examples only, with reference to the accompanying drawings, in which:

FIG. 1 depicts a known system for transmitting DVB signal,

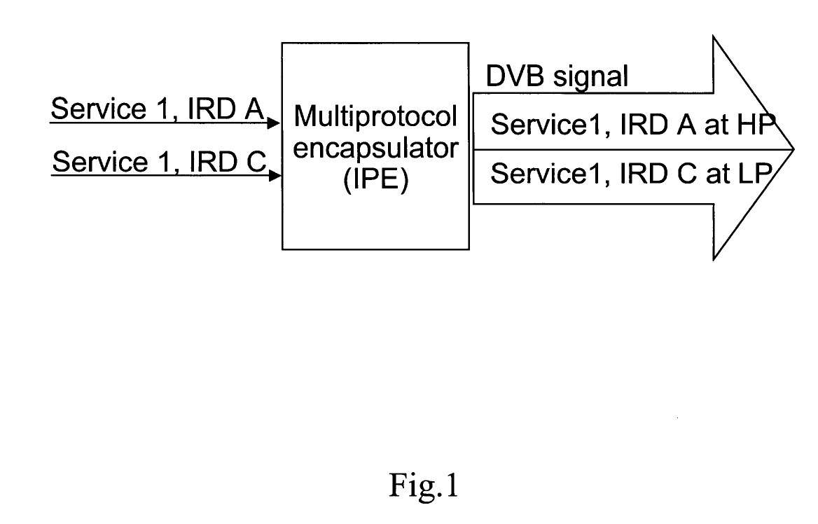

FIG. 2 depicts an example of a system for transmitting DVB signal where the content is encoded in accordance with a further embodiment of the invention,

FIG. 3 depicts a further embodiment of the invention,

FIG. 4 depicts still another further embodiment of the invention,

FIG. 5 depicts a terminal for receiving the DVB signal where the content is encoded in accordance with further embodiments of the invention,

FIG. 6 depicts a broadcast system where examples of the invention can be used.

### DESCRIPTION OF FURTHER EMBODIMENTS

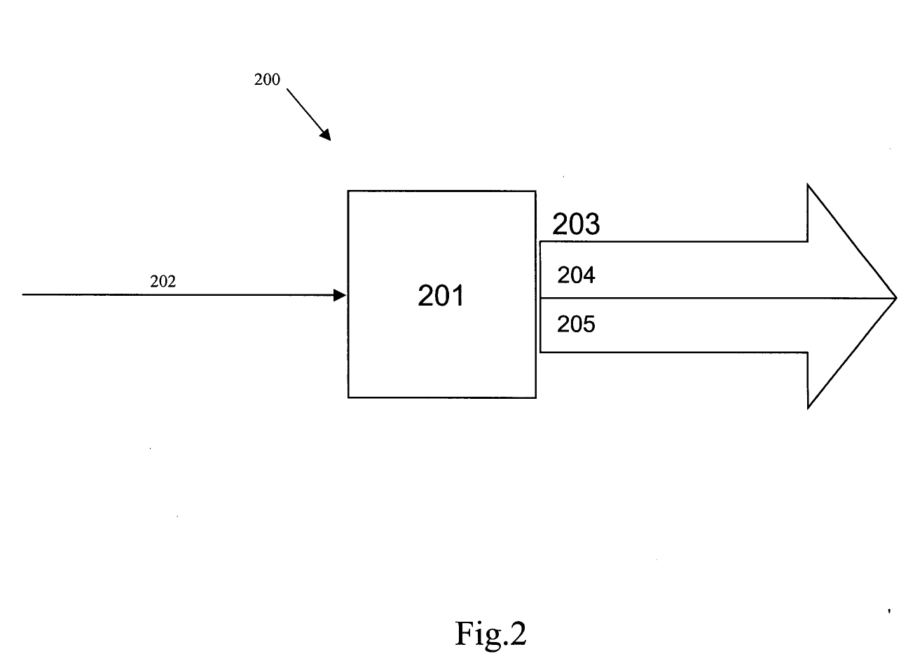

FIG. 2 discloses a scalable encoder apparatus 200 to be applied in the system and/or in the transmitter of various further embodiments. A scalable video coder can be an example of the scalable encoder 200. For example, either a resolution or a detail level could be scalable. The scalable encoder apparatus comprises a multiprotocol encapsulator (IPE) 201. The IPE 201 receives Service 1, IRD C, Scalable video base and enhancement protocol layers as separate IP streams as signal(s) 202. The DVB signal 203 comprises a first stream 204 and the second stream 205. The first stream is Service 1, IRD C base layer at high priority (HP). The second stream comprises Service 1, IRD A enhancement layer at low priority (LP). The base layer contains the low resolution video and is transmitted with the HP stream. The enhancement layer contains the extra information required for high resolution video and is transmitted with LP stream. Thus the content is not sent twice but the base layer and the enhancements (i.e. enhancement layer) are sent separately.

For example HP:QPSK, LP:QPSK hierarchical mode is used without limiting the number of services. This can be because the enhancements do not require full 10 Mbit, but, for example, the available 5 Mbit. Accordingly good mobile reception is guaranteed. The hierarchical modulation provides synergy when it is combined with the scalable video codec. In one embodiment of a scalable video codec the temporal scalability (frame rate) or spatial scalability (number of pixels) can be used. In yet another further embodiment the picture rate is scalable. Without scalable video codec the usage of hierarchical modulation is more limited.

The encoder, alternatively referred to as a service system, according to various further embodiments encodes the media streams for the user service. The service system knows the number of provided priority classes (two in case of the presented hierarchical modulation) and the target media bitrates for those priority classes a priori. Alternatively, the IP encapsulator (alternative referred to as the multiprotocol encapsulator) signals these values to the service system. The service system creates IP packets that are priority labeled based on their importance either manually or automatically using some a-priori knowledge. The number of different priority label values is equal to the known number of provided priority classes. For example, in a news broadcasting service, the audio has a higher priority than video, which in turn has a higher priority than auxiliary media enhancement data. Continuing with the example, further priority assignment can be made in a scalable coded video bitstream such that base layer IP packets can be assigned higher priority than enhancement layer IP packets. Practical means for signalling the priority include the following: IP Multicast is used and a separate multicast group address is assigned for each priority level. Alternatively, the priority bits in the IPv6 packet header can be used. Alternatively, it is often possible to use media-specific indications of priority in the RTP payload headers or RTP payloads. For example, the nal_ref_idc element in the RTP payload header of the H.264 RTP payload format can be used. Furthermore, the service system adjusts the bitrate of the IP packets assigned a certain priority label to match with the known media bitrates of the corresponding priority class. Means for bitrate adjustment include selection of audio and video encoding target bitrates. For example, many audio coding schemes, such as AMR-WB+, include several modes for different bitrates. Video encoders include a coder control block, which regulates the output bitrate of the encoder among other things. Means for video bitrate adjustment include the picture rate control and quantization step size selection for the prediction error pictures. Furthermore, media encoding can be done in a scalable fashion. For example, video can be temporally scalable, base layer being decidable at 7.5 Hz picture rate and base and enhancement layer together at 30 Hz picture rate. The base layer is then assigned a higher priority than the enhancement layer. In the following, we consider a case in which there are two priority classes, and therefore the service system generates two sets of IP packet streams, one referred herein to as high-priority (HP) stream and another referred to as low-priority (LP) stream.

### Various Further Embodiments Use the Hierarchical Priority Modulation in Broadcast

For many media compression schemes, one can assign a category of importance to individual bit strings of the coded media, henceforth called priority. In coded video, for example non-predictively coded information (Intra pictures) have a higher priority than predictively coded information (Inter pictures). Of the Inter pictures, those which are used for the prediction of other inter pictures (reference pictures) have a higher priority than those, which are not used for future prediction (non-reference pictures). Some audio coding schemes require the presence of codebook information before the playback of the content can start, and here the packets carrying the codebook have a higher priority than the content packets. When using MIDI, instrument definitions have a higher priority than the actual real-time MIDI stream. A person skilled in the art should easily be able to identify different priorities in media coding schemes based on the examples presented.

Priority can also be established based on “soft” criteria. For example, when a media stream encompasses audio and video packets, one can, in most practical cases, assume that the audio information is, from a user's perception's point of view, of higher importance than the video information. Hence, the audio information carries a higher priority than the video information. Based on the needs of an application, a person skilled in the art should be capable to assign priorities to different media types that are transported in a single media stream.

The loss of packets carrying predicatively coded media has normally negative impacts on the reproduced quality. Missing data not only leads to annoying artifacts for the media frame the packet belongs to, but the error also propagates to future frames due to the predictive nature of the coding process. Most of the media compression schemes mentioned above implement a concept of independent decoder refresh information (IDR). IDR information has, by its very nature, the highest priority of all media bit strings. Independent decoder refresh information is defined as information that completely resets the decoder to a known state. In older video compression standards, such as ITU-T H.261, an IDR picture is identical to an Intra picture. Modern video compression standards, such as ITU-T H.264, contain reference picture selection. In order to break all prediction mechanisms and reset the reference picture selection mechanism to a known state, those standards include a special picture type called IDR picture. For the mentioned audio and MIDI examples, an IDR consists of all codebook/instrument information necessary for the future decoding. An IDR period is defined herein to contain media samples from an IDR sample (inclusive) to the next IDR sample (exclusive), in decoding order. No coded frame following an IDR frame can reference a frame prior to the IDR frame.

One useful property of coded bit-streams is scalability. In the following, bit-rate scalability is described which refers to the ability of a compressed sequence to be decoded at different data rates. Such a compressed sequence can be streamed over channels with different bandwidths and can be decoded and played back in real-time at different receiving terminals.

Scalable multi-media is typically ordered into hierarchical layers of data. A base layer contains an individual representation of a multi-media clip such as a video sequence and enhancement layers contain refinement data in addition to the base layer. The quality of the multi-media clip progressively improves as enhancement layers are added to the base layer.

Scalability is a desirable property for heterogeneous and error prone environments such as the Internet and wireless channels in cellular communications networks. This property is desirable in order to counter limitations such as constraints on bit rate, display resolution, network throughput and decoder complexity.

If a sequence is downloaded and played back in different devices each having different processing powers, bit-rate scalability can be used in devices having lower processing power to provide a lower quality representation of the video sequence by decoding only a part of the bit-stream. Devices having higher processing power can decode and play the sequence with full quality. Additionally, bit-rate scalability means that the processing power needed for decoding a lower quality representation of the video sequence is lower than when decoding the full quality sequence. This is a form of computational scalability.

If a video sequence is pre-stored in a streaming server, and the server has to temporarily reduce the bit-rate at which it is being transmitted as a bit-stream, for example in order to avoid congestion in the network, it is advantageous if the server can reduce the bit-rate of the bit-stream whilst still transmitting a useable bit-stream. This can be achieved using bit-rate scalable coding.

Scalability can be used to improve error resilience in a transport system where layered coding is combined with transport prioritisation. The term transport prioritisation is used to describe mechanisms that provide different qualities of service in transport. These include unequal error protection, which provides different channel error/loss rates, and assigning different priorities to support different delay/loss requirements. For example, the base layer of a scalably encoded bit-stream may be delivered through a transmission channel with a high degree of error protection, whereas the enhancement layers may be transmitted in more error-prone channels.

Video scalability is often categorized to the following types: temporal, spatial, quality, and region—of-interest. These scalability types are described in the following. For all types of video scalability, the decoding complexity (in terms of computation cycles) is a monotonically increasing function of the number of enhancement layers. Therefore, all types of video scalability also provide computational scalability.

Temporal scalability refers to the ability of a compressed sequence to be decoded at different picture rates. For example, a temporally scalable coded stream may be decoded at 30 Hz, 15 Hz, and 7.5 Hz picture rate. There are two types of temporal scalability: non-hierarchical and hierarchical. In non-hierarchical temporally scalability, certain coded pictures are not used as prediction references for motion compensation (a.k.a. inter prediction) or any other decoding process for any other coded pictures. These pictures are referred to as non-reference pictures in modern coding standards, such as H.264/AVC. Non-reference pictures may be interpredicted from previous pictures in output order or both from previous and succeeding pictures in output order. Furthermore, each prediction block in the inter prediction may originate from one picture or, in bi-predictive coding, may be a weighted average of two source blocks. In conventional video coding standards, B-pictures provided means for temporal scalability. B-pictures are bi-predicted non-reference pictures, coded both from the previous and the succeeding reference picture in output order. Among other things, non-reference pictures are used to enhance perceived image quality by increasing the picture display rate. They can be dropped without affecting the decoding of subsequent frames, thus enabling a video sequence to be decoded at different rates according to bandwidth constraints of the transmission network, or different decoder capabilities. Whilst non-reference pictures may improve compression performance compared to reference pictures, their use requires increased memory as well as introducing additional delays.

In hierarchical temporal scalability, a certain set of reference and non-reference pictures can be dropped from the coded bistream without affecting the decoding of the remaining bitstream. Hierarchical temporal scalability requires multiple reference pictures for motion compensation, i.e. there is a reference picture buffer containing multiple decoded pictures from which an encoder can select a reference picture for inter prediction. In H.264/AVC coding standard, a feature called subsequences enables hierarchical temporal scalability as described in the following. Each enhancement layer contains sub-sequences and each sub-sequence contains a number of reference and/or non-reference pictures. A sub-sequence consists of a number of inter-dependent pictures that can be disposed without any disturbance to any other sub-sequence in any lower sub-sequence layer. Subsequence layers are hierarchically arranged based on their dependency on each other. When a sub-sequence in the highest enhancement layer is disposed, the remaining bitstream remains valid.

Spatial scalability allows for the creation of multi-resolution bit-streams to meet varying display requirements/constraints. In spatial scalability, a spatial enhancement layer is used to recover the coding loss between an up-sampled version of the re-constructed layer used as a reference by the enhancement layer, that is the reference layer, and a higher resolution version of the original picture. For example, if the reference layer has a Quarter Common Intermediate Format (QCIF) resolution, 176×144 pixels, and the enhancement layer has a Common Intermediate Format (CIF) resolution, 352×288 pixels, the reference layer picture must be scaled accordingly such that the enhancement layer picture can be appropriately predicted from it. There can be multiple enhancement layers, each increasing picture resolution over that of the previous layer.

Quality scalability is also known as Signal-to-Noise Ratio (SNR) scalability. It allows for the recovery of coding errors, or differences, between an original picture and its re-construction. This is achieved by using a finer quantiser to encode the difference picture in an enhancement layer. This additional information increases the SNR of the overall reproduced picture. Quality scalable video coding techniques are often classified further to coarse granularity scalability and fine granularity scalability. In coarse granularity scalability, all the coded data corresponding to a layer (within any two random access pictures for that layer) are required for correct decoding. Any disposal of coded bits of a layer may lead to an uncontrollable degradation of the picture quality. There are coarse quality scalability methods often referred to as leaky prediction in which the quality degradation caused by disposal of coded data from a layer is guaranteed to decay. In fine granularity scalability, the resulting decoding quality is monotonically increasing function of the number of bits decoded from the highest enhancement layer. In other words, each additional decoded bit improves the quality. There are also methods combining coarse and fine granularity scalability and reaching intermediate levels in terms of the number of scalability steps.

In region-of-interest scalability, the quality or resolution improvement is not uniform for an entire picture area, but rather only certain areas within a picture are improved in the enhancement layers.

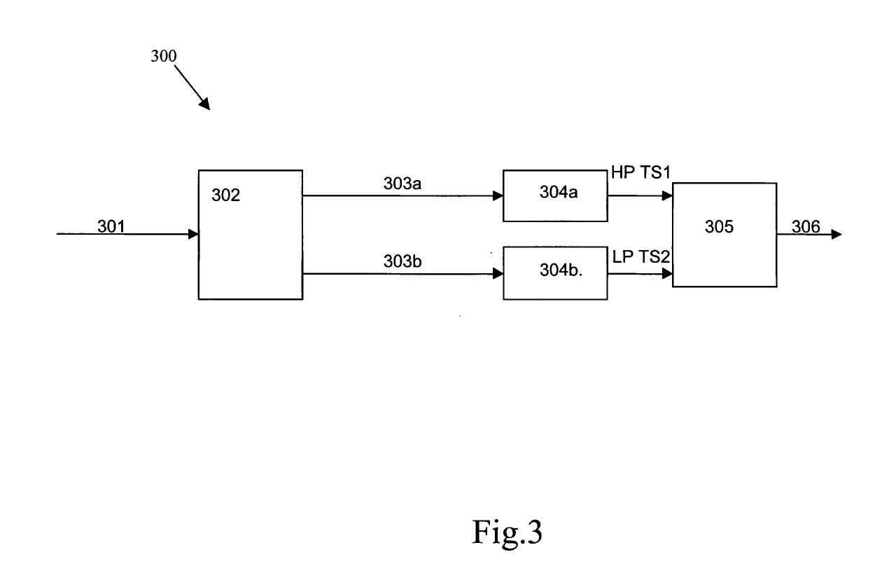

Referring to FIG. 3, there is being disclosed various further embodiments for transmitting the signal in accordance with the invention. The apparatus 300 obtains content 301. An example of the content can be a video stream. The apparatus comprises a service system 302. The service system 302 encodes the content 301 into two separate streams: a low quality stream 303a and into a high quality stream 303b. The high quality stream 303b is a so-called ‘add-in’ stream because it can be used to increase, for example double, the bitrate of the low quality stream 303a.

In various further embodiments the bit rate of the low quality stream 303a can, for example, be 256 kpbs. The bit rate of the high quality ‘add-in’ stream can, for example, be 256 kpbs. Thereby the total bitrate of the combined streams can in some embodiments increase to 512 kpbs.

In various further embodiments, the high quality stream 303b may not be consumed as such. However the high quality stream 303b is the ‘add-in’ to enhance the quality of the combined stream of the two streams 303a, 303b. On the other hand the low quality stream 303a can be consumed as a single stream. For example, when the reception conditions are bad.

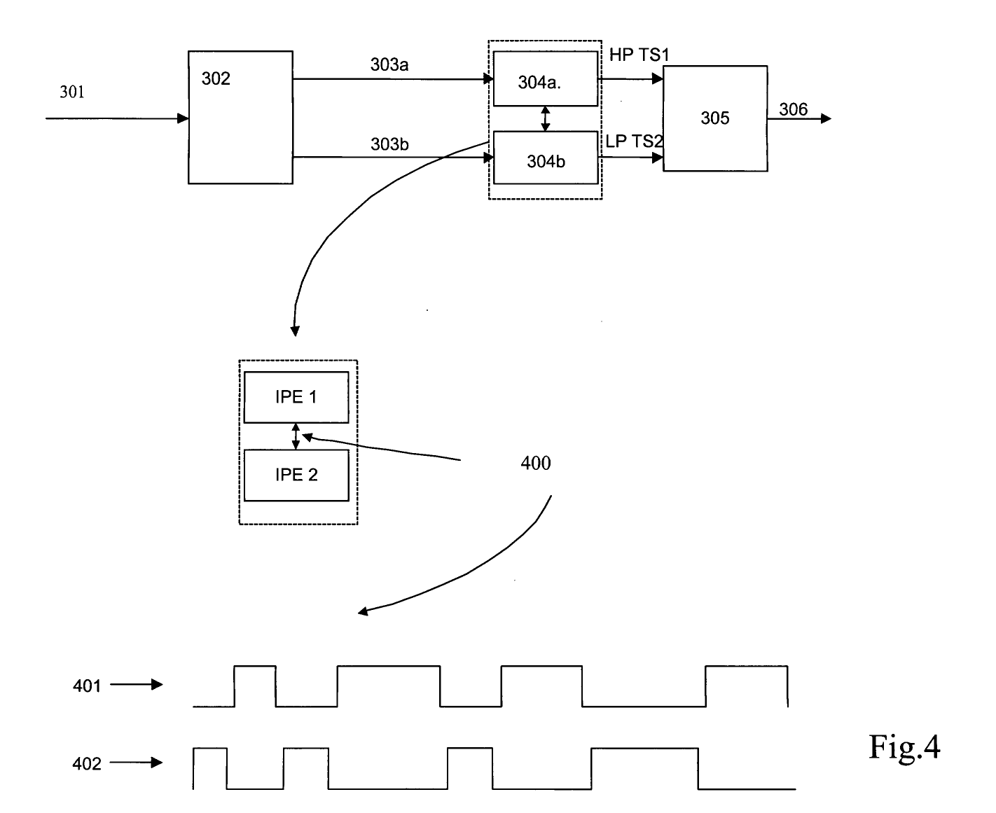

Referring back to the example of FIG. 3, the apparatus 300 further comprises a multiplexer (or IP encapsulator as in the example of FIG. 4) 304a. The low quality stream 303a is multiplexed into a separate transport stream TS1. The TS1 is carried using the high priority HP modulation. The high quality stream 303b is multiplexed in multiplexer (or IPE) 304b into a separate transport stream TS2. The TS2 is carried using the low priority LP modulation.

Still referring to the various embodiments of FIG. 3, the apparatus 300 comprises also a modulator 305. The modulator combines TS1, which comprises the high priority stream 303a, and TS2, which comprises the low priority stream 303b. The modulator 305 transmits TS1 and TS2 within a single signal 306. The modulator 305 uses hierarchical transmission (or modulation) as defined in ETSI EN 300 744. In this hierarchical modulation, TS1 is sent in high priority stream with its own channel coding rate and TS2 is sent in low priority stream with its own channel coding rate.

In various further embodiments if a receiver apparatus needs to consume only the limited quality stream, the receiver apparatus can filter HP TS1 stream of the received signal. On the other hand if the receiver apparatus needs to consume improved quality stream or in some cases maximum quality stream, the receiver apparatus uses both HP TS1 and LP TS2.

FIG. 4 depicts alternative further embodiments of the invention, where a phase-shift between TS streams is used. The FIG. 4 discloses an alternative for various further embodiments, where the receiver apparatus is not able to receive simultaneously both the HP stream and LP stream. Accordingly, FIG. 4 provides a further possibilities if the receiver is not able to so that. In an embodiment according to FIG. 4 the LP and HP streams are transmitted phase-shifted. The further embodiments of FIG. 4 comprise the apparatus 300 additionally comprising a phase-shift control 400. The phase-shift control 400 controls the outputs of IPE1 (the first multiprotocol encapsulator) and IPE2 (the second multiprotocol encapsulator) so that the LP's and HP's TS streams are not simultaneous. In FIG. 4 signal 401 depicts the output of IPE 1 containing the TS1 and signal 402 depicts the output of IPE 2 containing the TS2.

The IP encapsulator generates time-slices of HP and LP streams. The boundaries of a time-slices in the LP stream in terms of intended decoding or playback time are within a defined limited range compared to the intended decoding or playback time of a time-slice of the HP stream of the same user service. Means to match the time-slice boundaries include padding and puncturing of the MPE-FEC frame and bitrate adaptation of the coded bitstreams. Bitrate adaptation of coded bit-stream may include dropping of selected pictures from enhancement layers or moving reference pictures from the end of group of pictures from the HP stream to the LP stream, for example. Matching the time-slice boundaries of HP and LP streams helps in reducing the expected tune-in delay, i.e. the delay from the start of the radio reception until the start of media playback. Moreover, the boundaries streams within an HP-stream time-slice are aligned in terms of their intended decoding or playback time. For example, the timestamp of the first video audio and video sample in the same time-slice should be approximately equal.

In a further embodiment of the invention, the IP encapsulator generates phase-shifted transmission of the HP and LP stream of a single user service. In another embodiment of the invention two IP encapsulators can be used with phase shifting. That is, bursts of LP and HP streams of the same user service are not transmitted in parallel but rather next to each other. A time-slice of the LP stream is preferably sent prior to the time-slice of the HP stream that corresponding the LP time-slice in terms of media decoding or playback time. Consequently, if a terminal starts reception during the between the transmission of an LP-stream time-slice and the corresponding HP-stream time-slice, it is able to decode and play the HP-stream time-slice. If the transmission order of time-slices were the other way round and the first received time-slice was from the LP stream, the receiver would not be able to decode the first LP-stream time-slice and the tune-in delay would be longer.

If the IP encapsulator generates phase-shifted transmission of the HP and LP stream of a single user service, it has to also provide means for receivers to adjust the initial buffering delay correctly. One means for adjustment is to provide an initial buffering delay for each transmitted time-slicing burst. Another means is to indicate the number and the transmission order of priority classes in advance or fix them in a specification. Consequently, a receiver would know how many time-slice bursts for a particular period of media decoding or playback time are still to be received before starting of decoding.

When the reception starts, the receiver buffers such an amount of data that enables it to reconstruct a single media bitstream from an HP stream and an LP stream and input the bitstream to the media decoder in a fast enough pace. If initial buffering delay is signalled per time-slice burst, then the receiver buffers as suggested in the singling. If the number of priority classes and their transmission order is known, then the receiver buffers as long as the last time-slice corresponding to the first received period of media decoding or playout time has been received.

The receiver organizes media samples from HP-stream and LP-stream time-slices back to a single bitstream, in which media samples are in the decoding order specified in the corresponding media coding specification. If the transmission follows IP multicast, this is typically done using the RTP timestamp of the samples. If media-specific means are used to transmit samples in different time-slices, then the interleaved packetization mode of the RTP payload format is used and payload format provides means for de-interleaving the samples back to their decoding order. For example, a decoding order number (DON) can be derived for each Network Abstraction Layer (NAL) unit of H.264 when the interleaved packetization mode of H.264 RTP payload format is used.

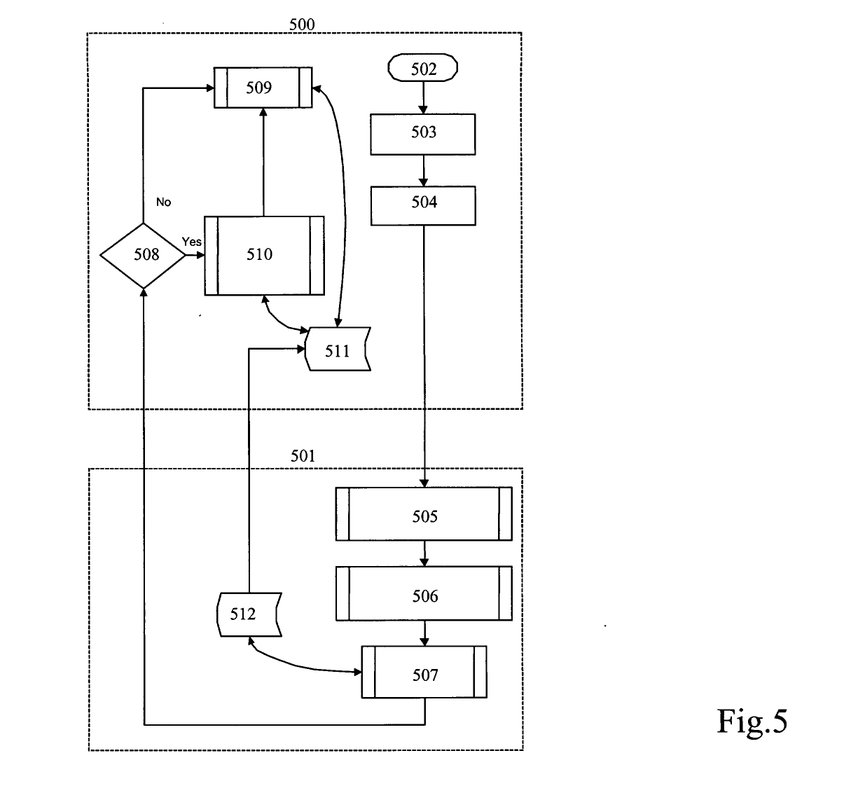

FIG. 5 depicts the cooperation of a terminal 500 and a receiver 501 when receiving the DVB signal where the content is encoded in accordance with various further embodiments of the invention. The receiver 501 receives the wireless digital broadband signal such as DVB-H signal. The user selects the desired service in the block 503 from electronic service guide (ESG) that is stored in the terminal. The receiver may select either service that consumes total of 256 kbps or total of 512 kbps if data in the ESG shows that these possibilities are available. The terminal 500 then creates corresponding filters in block 504. Filter is created for the IP streams needed for obtaining service. For example the larger 512 kbps service includes at least two IP streams. Therefore at least two filters are needed for such.

The receiver 501 performs service discovery for the requested IP streams in the block 505. In the block 505 PID is being discovered through PAT, PMT and INT. Furthermore discovery of modulation parameters of the LP and HP stream takes place. The discovery of the modulated parameter depends on the selected service, i.e., whether it is carried within LP or HP stream. Moreover, modulation parameters for the HP and LP streams can be discovered for example by means of hierarchy bit in terrestrial delivery system descriptor. In the block 506 the receiver 501 adjusts reception between HP and LP streams. If the low bitrate service of 256 kbps was selected, the receiver 501 does not need to switch between HP and LP streams, since all data is carried within HP stream. If the high bitrate service of 512 kbps was selected, the receiver 501 switches between HP and LP streams e.g. after every second burst. The receiver 501 comprises also a buffer management means 507 and a receiver buffer 508. The buffer management block 507 controls buffer resources and forwards received data to terminal 500 once the buffer becomes full.

The terminal 500 comprises a stream assembling controller 508, which checks whether stream assembling is needed. The controller 508 checks whether the low bitrate service or the high bitrate service has been selected. In case of the high bitrate service, some assembling is needed. In the block 510 the terminal assembles high bitrate service from the low bitrate stream and from the enhancement. In one embodiment of the invention the layered codecs assemble the low quality stream originated from the HP TS and the enhancement stream originated from the LP TS to a single stream. In the block 509 the stream is consumpted. The block 509 provides either directly received low bitrate service or assembled high bitrate service for consumption. The terminal 500 further comprises also a terminal memory 511 that may be used in the assembling, buffering and in the stream consumption.

The terminal can be a mobile hand-held terminal receiving DVB-H signal. There are various ways to implement the receiver apparatus

### Handheld Devices

Handheld devices are usually battery powered and are becoming a usual companion in our day-to-day nomadic activities. Besides some of them, like the cellular mobile phones would easily allow interactive applications since they have the return channel. Examples of handheld devices: Cellular mobile phones comprising broadcast receiving capabilities. PDAs: they have the advantage to have, generally speaking, bigger screens than mobile phones, however there is a tendency to mix both devices. Portable video-game devices: their main advantage is that the screen is very well prepared for TV applications and that they are becoming popular between e.g. youngsters.

### Portable Devices

Portable devices are those that, without having a small screen, are nomadic and battery powered. As an example: Flat screen battery powered TV set: there are some manufacturers that are presenting such devices, as an example of their use: to allow a nomadic use inside the house (from the kitchen to the bedroom). Portable DVD players, Laptop computers etc. are other examples.

### In-Car Integrated Devices

In-car integrated devices are also of applicable platform. The devices integrated in private cars, taxis, buses, and trams. Various screen sizes are expected.

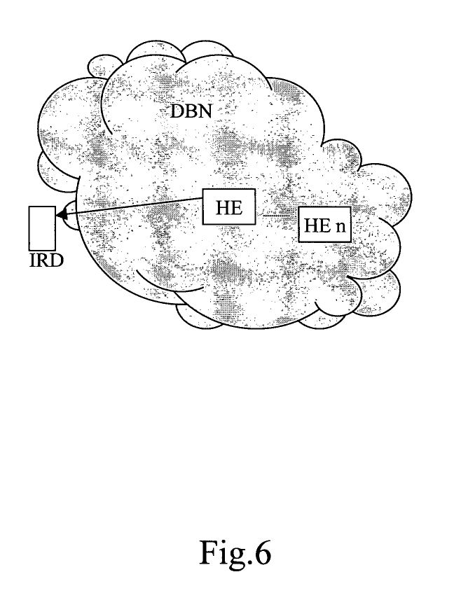

Some embodiments of the invention apply the system of FIG. 6. The Integrated Receiver Device (IRD) operates preferably under coverage of the Digital Broadcast Network (DBN). Alternatively, IRD can be referred to as End User Terminal (EUT). IRD can be capable of receiving IP based services that DBN is providing. The DBN is based on DVB, preferably DVB-T, and the transmission of the DBN contains TSs based on the hierarchical transmission modulation. The transmission is also preferably wireless broadband transmission. Before transmission data is processed in the DBN. The network DBN of FIG. 6 can be configured to receive the service content from the content providers. The service system of DBN encodes the content into two separate streams. The first (so-called low quality) stream and the second (so-called high quality) stream. The high quality stream contains additional information that can be used to increase the total bitrate of the combined streams. Headend(s) HEs of the system multiplexes the streams so that the first stream is multiplexed into a separate TS1 and the second stream is multiplexed into a separate TS2. TS1 multiplexing is carried out using HP hierarchical modulation. TS2 multiplexing is carried out using LP hierarchical modulation. The modulator of the HEs transmits TS1 and TS2 within a single signal to the IRD.

The DBN transmission is wireless or mobile transmission to the IRD based on DVB-H. Thus, data can be transferred wirelessly.

Still referring to the example of FIG. 6, headends (HE)s containing IP encapsulators perform a multi-protocol encapsulation (MPE) and places the IP data into Moving Picture Experts Group-Transport Stream (MPEG-TS) based data containers. The HEs perform the generation of the tables, the linking of the tables and the modification of the tables.

The TSs so produced are transmitted over the DVB-H data link. The IRD receives digitally broadcast data. The IRD receives the descriptor and also the TSs in accordance with the hierarchical broadband transmission and TSs with priorities. The IRD is able to identify the TSs having the priority indication. Thus, the DBN has signalled the priority of the TS of hierarchical transmission. IRD parses transport_stream_id from received NIT, for example. The IRD is able to separate TSs with different priority. Also IRD can categorise the TSs based on their hierarchical priority. Therefore the receiver IRD, if desiring to consume only limited quality stream, may use HP TS1 stream. Now the LP TS2 is not consumed at all. Furthermore the receiver IRD, if desiring to consume better quality stream, may use both HP TS1 and LP TS2 streams, thereby having higher bitrate for the consumed service.

### Ramifications and Scope

Although the description above contains many specifics, these are merely provided to illustrate the invention and should not be constructed as limitations of the invention's scope. It should be noted that the many specifics can be combined in various ways in a single or multiple embodiments. Thus it will be apparent to those skilled in the art that various modifications and variations can be made in the apparatuses and processes of the present invention without departing from the spirit or scope of the invention.

1. An apparatus for transmitting a digital broadcast signal using a hierarchical modulation comprising a high priority stream and a low priority stream, the apparatus comprising:
at least one encoder for encoding service content to be transmitted into two streams so that
a first stream is configured to be transmitted with said high priority stream, and
a second stream to be transmitted with said low priority stream is configured to contain additional information.

2. An apparatus according to claim 1, wherein the first stream comprises a low quality stream and the second stream comprises a high quality stream so that a combination of the first and second streams provides an increased bitrate for the service content.

3. An apparatus according to claim 1, wherein the first stream and the second stream contains the same service content.

4. An apparatus according to claim 1, wherein the first stream comprises a base layer containing low resolution video.

5. An apparatus according to claim 1, wherein the second stream comprises an enhancement layer containing the additional information for high resolution video.

6. An apparatus according to claim 1 or 2, wherein the first stream and the second stream are transmitted at the same time.

7. An apparatus according to claim 1 or 2, wherein the first stream and the second stream are configured to be transmitted so that there is a phase shift between them.

8. An apparatus according to claim 1, wherein the digital broadcast signal comprises a mobile digital broadband broadcast signal such as DVB-H.

9. An apparatus for receiving a digital broadcast signal using a hierarchical modulation comprising a high priority stream and a low priority stream, the apparatus comprising:
at least one decoder for decoding service content received in two streams so that
a first stream is configured to be received with said high priority stream, and
a second stream to be received with said low priority stream is configured to contain additional information.

10. An apparatus according to claim 9, wherein said apparatus comprises a mobile receiver for receiving a DVB-H transmission.

11. A method for transmitting a digital broadcast signal using a hierarchical modulation comprising a high priority stream and a low priority stream, the method comprising:
encoding content to be transmitted into two streams so that
a first stream is configured to be transmitted with said high priority stream, and
a second stream to be transmitted with said low priority stream is configured to contain additional information.

12. A method for receiving a digital broadcast signal using a hierarchical modulation comprising a high priority stream and a low priority stream, the method comprising:
decoding content received in two streams so that
a first stream is configured to be received with said high priority stream, and
a second stream to be received with said low priority stream is configured to contain additional information.

13. An encoder for encoding a digital broadcast signal using a hierarchical modulation comprising a high priority stream and a low priority stream, the encoder comprising:
encoding means for encoding content to be transmitted into two streams so that
a first stream is configured to be transmitted with said high priority stream, and
a second stream to be transmitted with said low priority stream is configured to contain additional information.

14. A mobile terminal configured to process data packets that are transmitted as one or more transport stream packets containing packet identifiers, the terminal comprising:
a first memory for storing electronic service guide information,
a second memory for storing a service discovery data that links the service discovery data between low and high priority streams;
means for selecting a service from the electronic service guide for rendering;
a transport stream filter for filtering at least the service discovery data using packet identifiers;
wherein the filtering is based on a selection between a low priority stream and a high priority stream for receiving and rendering the service accordingly.
